(19) United States
(12) Patent Application Publication
(10) Pub. No.: US 2025/0095173 A1
(43) Pub. Date: Mar. 20, 2025

(54) TRAINING A NEURAL NETWORK TO GENERATE A DENSE DEPTH MAP FROM IMAGE AND LIDAR DATA

(71) Applicant: QUALCOMM Incorporated, San Diego, CA (US)

(72) Inventors: Savitha Srinivasan, San Diego, CA (US); Varun Ravi Kumar, San Diego, CA (US); Senthil Kumar Yogamani, Headford (IE)

(21) Appl. No.: 18/467,035

(22) Filed: Sep. 14, 2023

(51) Int. Cl. G06T 7/50; G06T 5/00

(52) U.S. Cl. CPC G06T 7/50; G06T 5/70; G06T 2207/20081; G06T 2207/20084

(57) ABSTRACT

An example device for training a neural network includes a memory configured to store a neural network model for the neural network; and a processing system comprising one or more processors implemented in circuitry, the processing system being configured to: extract image features from an image of an area, the image features representing objects in the area; extract point cloud features from a point cloud representation of the area, the point cloud features representing the objects in the area; add Gaussian noise to a ground truth depth map for the area to generate a noisy ground truth depth map, the ground truth depth map representing accurate positions of the objects in the area; and train the neural network using the image features, the point cloud features, and the noisy ground truth depth map to generate a depth map.

### TECHNICAL FIELD

This disclosure relates to artificial intelligence, particularly as applied to autonomous driving systems.

### BACKGROUND

Techniques are being researched and developed related to autonomous driving and advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques for training a neural network to process multi-modal data captured by various sensors of, e.g., a vehicle, to determine positions of objects relative to a position of the vehicle. For example, the vehicle may include one or more cameras and a light detection and ranging (LiDAR) unit. The cameras and LiDAR unit may capture image and point cloud data, respectively, which may form the multi-modal data. According to the techniques of this disclosure, a neural network may be trained to generate a depth map using features extracted from the multi-modal data, e.g., image features and point cloud features (which may also be referred to as LiDAR features). In particular, a ground truth depth map may be used, which represents accurate positions of the objects. According to the techniques of this disclosure, Gaussian noise may be added to the ground truth depth map to form a noisy ground truth depth map, then the neural network may be trained to denoise the noisy ground truth depth map to reproduce the ground truth depth map. In this manner, the neural network may then be trained to denoise a depth map generated from the camera features and the point cloud features, which may be fused using cross-attention into a fused feature representation to generate a predicted depth map.

In one example, a method of training a neural network includes extracting image features from an image of an area, the image features representing objects in the area; extracting point cloud features from a point cloud representation of the area, the point cloud features representing the objects in the area; adding Gaussian noise to a ground truth depth map for the area to generate a noisy ground truth depth map, the ground truth depth map representing accurate positions of the objects in the area; and training a neural network using the image features, the point cloud features, and the noisy ground truth depth map to generate a depth map.

In another example, a device for training a neural network includes a memory configured to store a neural network model for the neural network; and a processing system comprising one or more processors implemented in circuitry, the processing system being configured to: extract image features from an image of an area, the image features representing objects in the area; extract point cloud features from a point cloud representation of the area, the point cloud features representing the objects in the area; add Gaussian noise to a ground truth depth map for the area to generate a noisy ground truth depth map, the ground truth depth map representing accurate positions of the objects in the area; and train the neural network using the image features, the point cloud features, and the noisy ground truth depth map to generate a depth map.

In another example, a computer-readable storage medium has stored thereon instructions that, when executed, cause a processing system to extract image features from an image of an area, the image features representing objects in the area; extract point cloud features from a point cloud representation of the area, the point cloud features representing the objects in the area; add Gaussian noise to a ground truth depth map for the area to generate a noisy ground truth depth map, the ground truth depth map representing accurate positions of the objects in the area; and train the neural network using the image features, the point cloud features, and the noisy ground truth depth map to generate a depth map.

In another example, a device for training a neural network includes means for extracting image features from an image of an area, the image features representing objects in the area; means for extracting point cloud features from a point cloud representation of the area, the point cloud features representing the objects in the area; means for adding Gaussian noise to a ground truth depth map for the area to generate a noisy ground truth depth map, the ground truth depth map representing accurate positions of the objects in the area; and means for training a neural network using the image features, the point cloud features, and the noisy ground truth depth map to generate a depth map.

In another example, a device for processing image data using a neural network includes: a memory configured to store a neural network model for the neural network, the neural network having been trained using Gaussian noise added to a ground truth depth map for a first area, first image features extracted from a first image of the first area, and point cloud features extracted from a first point cloud representation of the first area, the first image features representing first objects in the first area, and the first point cloud features representing the first objects in the first area; and a processing system comprising one or more processors implemented in circuitry, the processing system being configured to: extract second image features from a second image of a second area, the second image features representing second objects in the second area; extract second point cloud features from a second point cloud representation of the second area, the second point cloud features representing the second objects in the second area; and provide the second image features and the second point cloud features to the neural network to generate a depth map for the second area.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an autonomous driving controller according to techniques of this disclosure.

FIG. 2 is a block diagram illustrating an example set of components of an autonomous driving controller according to techniques of this disclosure.

FIG. 3 is a block diagram illustrating an example set of components that may be included in a depth determination unit according to techniques of this disclosure.

FIG. 4 is a block diagram illustrating an example vehicle with a multi-camera system and an autonomous driving controller according to techniques of this disclosure.

FIG. 5 is a flowchart illustrating an example method of training a neural network according to techniques of this disclosure.

### DETAILED DESCRIPTION

Depth estimation is an important component of autonomous driving (AD), autonomous driving assistance systems (ADAS), or other systems used to partially or fully autonomously control a vehicle or other device, e.g., for robot navigation. Depth estimation may also be used for extended reality (XR) related tasks, such as augmented reality (AR), mixed reality (MR), or virtual reality (VR). Depth information is important for accurate 3D detection and scene representation. Depth estimation for such techniques may be used for autonomous driving, assistive robotics, augmented reality/virtual reality scene composition, image editing, or other such techniques. Other types of image processing can also be used for AD/ADAS or other such systems, such as semantic segmentation, object detection, or the like.

Autonomous vehicles may use various sensors such as light detection and ranging (LiDAR) units, RADAR units, one or more cameras (e.g., monocular cameras, stereo cameras, or multi-camera arrays, which may face different directions). LiDAR scans generally provide sparse depth measurements, which is often insufficient to accurately estimate the depth of a scene, which brings about the need for dense depth maps. While dense depth maps help with several downstream tasks, such as 3D object detection and instance segmentation, they are not easy to obtain. The problem of obtaining dense depth maps from easily-accessible sparse sensor data is referred to as depth completion. The goal of depth completion is to fill in the missing depth information in sensor outputs to produce accurate, dense depth maps. This problem may be addressed using strategies such as multi-sensor fusion (e.g., a combination of LiDAR and camera), or even monocular depth estimation.

Neural networks may use diffusion models to generate data. Diffusion models are probabilistic models that map a signal to noise and use the mapping to generate new samples from the distribution. Diffusion models are particularly appealing for autonomous driving considering possible corruptions to sensor data (such as due to bad weather). Usage of diffusion models could also be seen as a predictive modeling strategy, which helps address sensor occlusion. Additionally, the distinct steps in the diffusion process allow for model training once, then using the model for inference across different use-cases. This decoupling between training and inference has an inherent computational advantage.

While diffusion models have shown impressive results for image generation, their use in deterministic tasks such as object detection and semantic segmentation is just starting to be explored. The depth completion problem can also be formulated as a generative task using conditional denoising diffusion probabilistic models (DDPM). This disclosure describes techniques including the use of DDPM for depth completion from sparse point clouds, guided by camera input.

Although monocular depth estimation might not give accurate results, monocular depth estimation may be used to guide the diffusion process. DDPMs may gradually add Gaussian noise to ground truth data. Conditional DDPMs may be used to combine ground truth dense depth maps and monocular depth estimates to obtain a noisy (perturbed) depth map in a forward diffusion process. A neural network may then be trained to refine the noisy depth map given a fused feature map from LiDAR and camera inputs.

In this manner, conventional camera and LiDAR components may be used by a neural network-based depth determination unit to accurately generate dense depth maps from the sparse point clouds generated by the LiDAR component. This may improve the generation of dense depth maps without the necessity of additional sensors, thereby improving the fields of autonomous driving, ADAS, and image processing generally. Furthermore, these techniques may improve the functioning of a depth determination unit, in that the depth determination unit can use these techniques to accurately generate a dense depth map.

Deep fusion of camera and LiDAR inputs, along with the use of monocular depth estimates, may allow a depth estimation neural network model to better handle sparsity and occlusions in data, resulting in more accurate depth predictions. A benefit of using DDPM in these techniques is to model the depth completion process as a generative task, allowing the model to learn from corrupted ground truth data and predict the actual depth map. DDPM is not used specifically for uncertainty estimation, although DDPM can still provide a measure of uncertainty in predictions. The use of a diffusion probabilistic model allows for uncertainty estimation in the predictions, which can be useful in downstream tasks such as robot navigation or autonomous driving.

By leveraging the strengths of both camera and LiDAR inputs, the model can overcome the limitations of each modality and provide more robust depth estimates. A camera encoder can be reused for both depth estimation and fusion tasks, reducing the computational cost and improving the efficiency of the model. This approach can be applied to a wide range of applications where depth estimation is required, including robotics, augmented reality, and autonomous driving, making it a versatile and widely applicable solution.

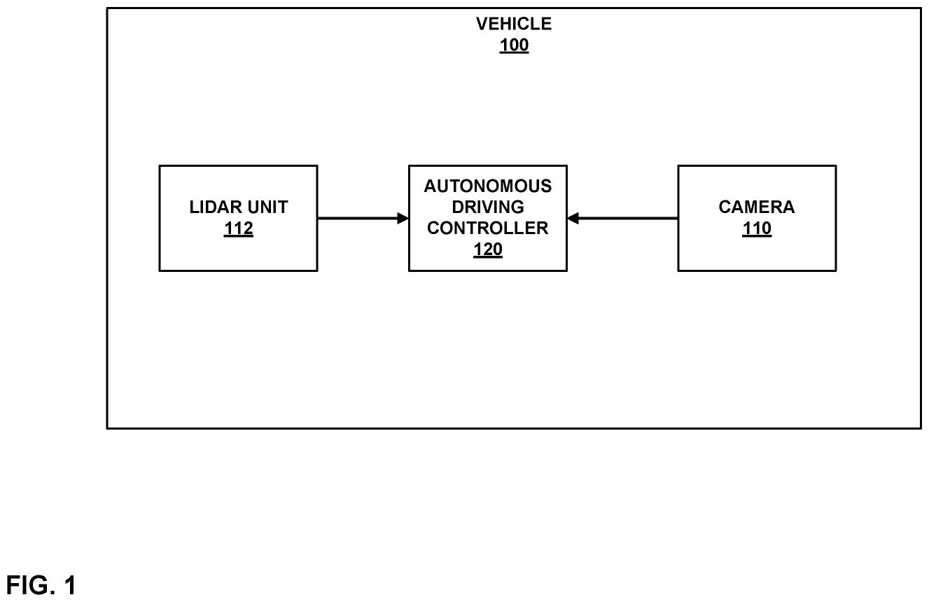

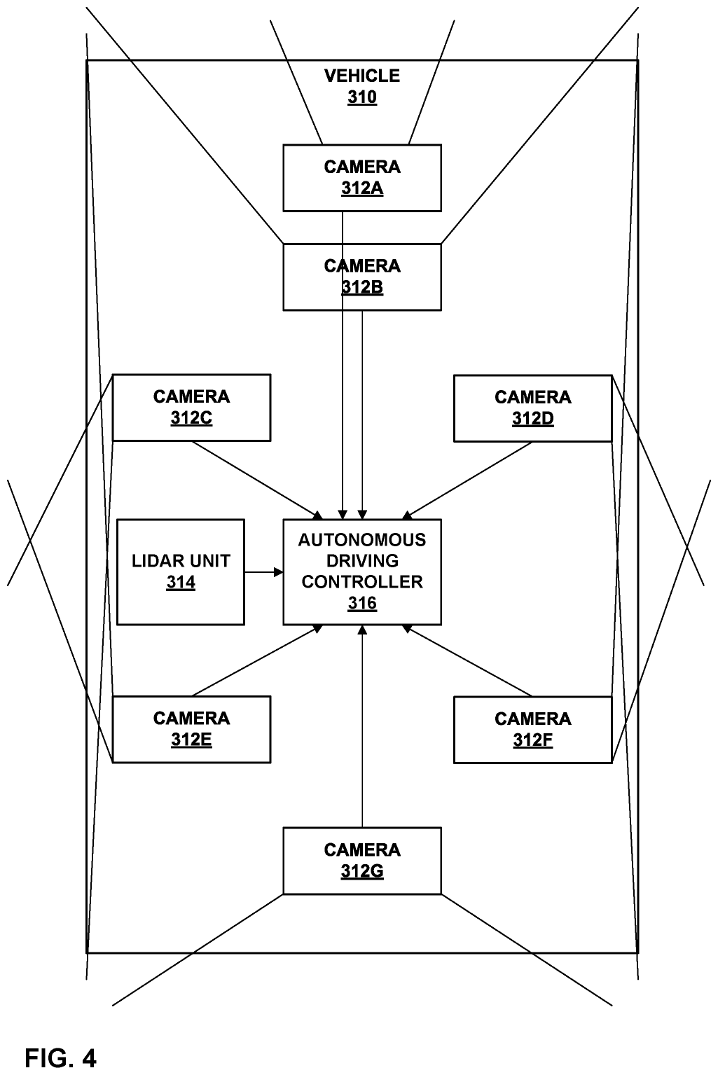

FIG. 1 is a block diagram illustrating an example vehicle 100 including an autonomous driving controller 120 according to techniques of this disclosure. In this example, vehicle 100 includes camera 110, light detection and ranging (LiDAR) unit 112, and autonomous driving controller 120. Camera 110 is a single camera in this example. While only a single camera is shown in the example of FIG. 1, in other examples, multiple cameras may be used. However, the techniques of this disclosure allow for depth to be calculated for objects in images captured by camera 110 without additional cameras. In some examples, multiple cameras may be employed that face different directions, e.g., front, back, and to each side of vehicle 100, e.g., as shown in FIG. 4. Autonomous driving controller 120 may be configured to calculate depth for objects captured by each of such cameras.

LiDAR unit 112 provides LiDAR data (e.g., point cloud data) for vehicle 100 to autonomous driving controller 120. LiDAR unit 112 may, for example, determine a point cloud for a three-dimensional area, where camera 110 also captures an image of the area. The point cloud may generally includes points corresponding to surfaces or objects in the area identified by a light (e.g., laser) emitted by LiDAR unit 112 and reflected back to LiDAR unit 112. Based on the angle of emission of the light from LiDAR unit 112 and time taken for the light to traverse from LiDAR unit 112 to the object and back, LiDAR unit 112 can determine a three-dimensional coordinate for the point.

Autonomous driving controller 120 receives image frames captured by camera 110 at a high frame rate, such as 30 fps, 60 fps, 90 fps, 120 fps, or even higher. Autonomous driving controller 120 also receives point cloud data captured by LiDAR unit 112 at a corresponding rate, such that a point cloud is paired with the image frame (or frames of a multi-camera system). Autonomous driving controller 120 may include a neural network trained according to the techniques of this disclosure to generate a depth map using fused features extracted from the frame(s) and the point cloud.

According to the techniques of this disclosure, image features may be extracted from an image frame representing an image of an area (e.g., an area in front of vehicle 100), and point could features may be extracted from a point cloud generated by LiDAR unit 112 for the same area. As discussed in greater detail below, the image features and point cloud features may be fused to form fused features. The neural network may generate depth maps from the fused features. In order to train the neural network, a ground truth dense depth map may be used, to compare the generated depth maps to the ground truth dense depth map. More particularly, a loss function may be used that calculates differences between the generated depth maps and the ground truth dense depth map, and values calculated using the loss function may be used to update a neural network model for the neural network.

In particular, when training the neural network, Gaussian noise may be added to the ground truth dense depth map to form a noisy ground truth depth map. The neural network may then denoise the noisy ground truth dense depth map to reconstruct the ground truth dense depth map. The loss function may generally represent a degree of loss between the reconstructed ground truth dense depth map and the original dense depth map, taking account of the image features and the point cloud features as well.

In this manner, neural networks or other AI/ML units may be trained to detect depth from an image and point cloud (LiDAR) data and/or other multi-modal data. Autonomous driving controller 120 may use the depths of the objects when determining how best to control vehicle 100, e.g., whether to maintain or adjust speed (e.g., to brake or accelerate), and/or whether to turn left or right or to maintain current heading of vehicle 100.

Additionally or alternatively, these techniques may be employed in advanced driving assistance systems (ADAS). Rather than autonomously controlling vehicle 100, such ADASs may provide feedback to a human operator of vehicle 100, such as a warning to brake or turn if an object is too close. Additionally or alternatively, the techniques of this disclosure may be used to partially control vehicle 100, e.g., to maintain speed of vehicle 100 when no objects within a threshold distance are detected ahead of vehicle 100, or if a separate vehicle is detected ahead of vehicle 100, to match the speed of the separate vehicle if the separate vehicle is within the threshold distance, to prevent reducing the distance between vehicle 100 and the separate vehicle.

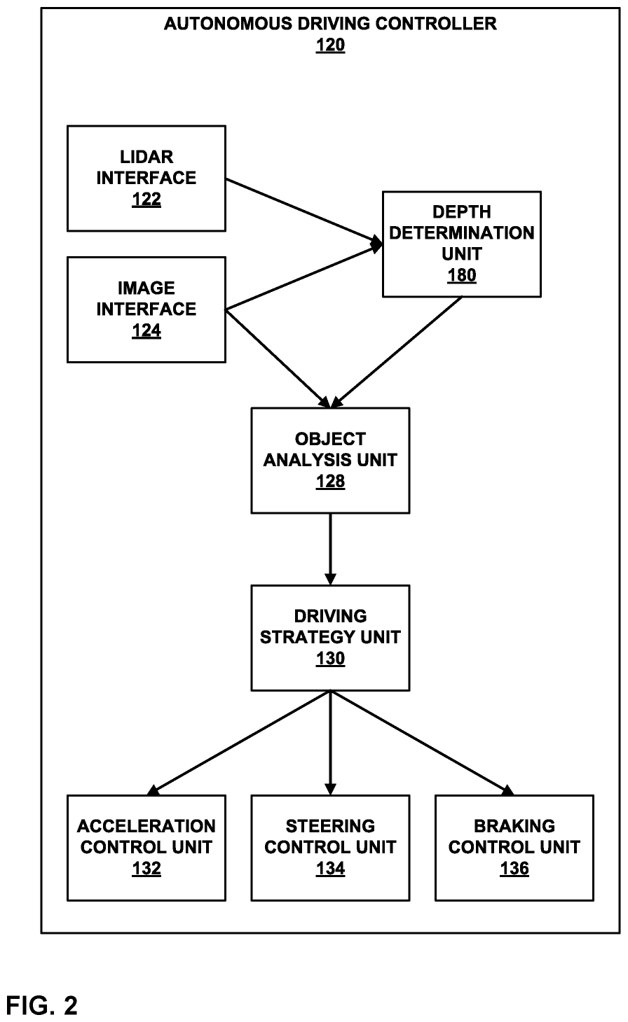

FIG. 2 is a block diagram illustrating an example set of components of autonomous driving controller 120 of FIG. 1 according to techniques of this disclosure. In this example, autonomous driving controller 120 includes LiDAR interface 122, image interface 124, depth determination unit 180, object analysis unit 128, driving strategy unit 130, acceleration control unit 132, steering control unit 134, and braking control unit 136.

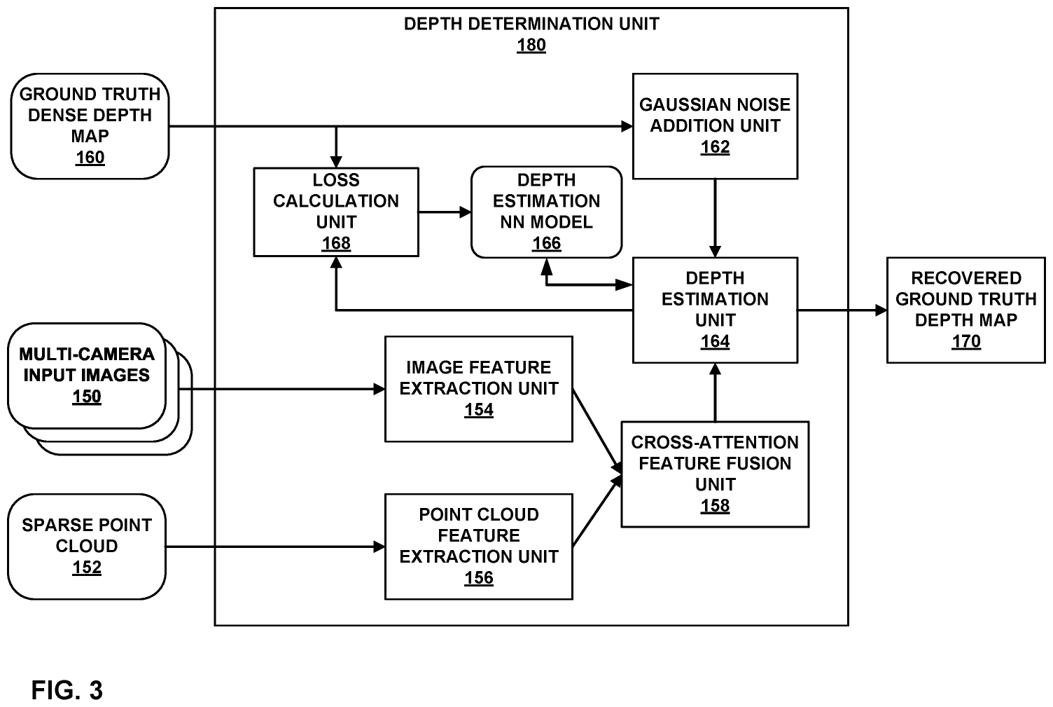

In general, LiDAR interface 122 represents an interface to LiDAR unit 112 of FIG. 1, which receives LiDAR data (e.g., point cloud data) from LiDAR unit 112 and provides the LiDAR/point cloud data to depth determination unit 180. In particular, as described in greater detail below with respect to FIG. 3, depth determination unit 180 may extract point cloud features from the point cloud data and image features from the image frame, fuse the image features with the point cloud features, and then determine a depth map from the fused features using a neural network. To train the neural network, per the techniques of this disclosure, initially, a ground truth depth map may be used. The ground truth depth map may be a dense depth map, that is, substantially denser than the point cloud generated by and received from LiDAR unit 112 via LiDAR interface 122.

Depth determination unit 180 may add Gaussian noise to the ground truth depth map. In some examples, depth determination unit 180 may add a variety of levels of Gaussian noise to the ground truth depth map to form a variety of different noisy ground truth depth maps. A neural network of depth determination unit 180 may then denoise the noisy ground truth depth map(s) using the fused features, including image features and point cloud features, and compare the resulting recovered ground truth depth map(s) to the original ground truth depth map using a loss function. A neural network model may then be updated based on the loss function to train the neural network.

Image interface 124 may also provide the image frames to object analysis unit 128. Likewise, depth determination unit 180 may provide depth values for objects in the images to object analysis unit 128. Object analysis unit 128 may generally determine where objects are relative to the position of vehicle 100 at a given time, and may also determine whether the objects are stationary or moving. Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

The various components of autonomous driving controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components that may be included in depth determination unit 180 of FIG. 2. In this example, depth determination unit 180 includes image feature extraction unit 154, point cloud feature extraction unit 156, cross-attention feature fusion unit 158, Gaussian noise addition unit 162, depth estimation neural network (NN) model 166, and loss calculation unit 168. Image feature extraction unit 154 may receive one or more of images, e.g., multi-camera input images 150. Point cloud feature extraction unit 156 may receive sparse point cloud 152. Image feature extraction unit 154 may extract image features from multi-camera input images 150, while point cloud feature extraction unit 156 may extract point cloud features from sparse point cloud 152. Cross-attention feature fusion unit 158 may fuse the point cloud features with the image features to generate fused feature data.

Multi-modal inputs, such as image and point cloud/LiDAR inputs, may help to make more accurate predictions of depth maps, reduce reliance on a single sensor, and also address common issues such as sensor occlusion, e.g., if an object is obstructing one or more cameras and/or the LiDAR unit at a given time. According to the techniques of this disclosure, ground truth dense depth map 160 may be one of only a limited number of ground truth dense depth maps used to train depth estimation NN model 166. A pipeline for depth determination, per the techniques of this disclosure, may generally be divided into two parts: 1) deep feature fusion and monocular depth estimation, and 2) a conditional denoising diffusion probabilistic model. Monocular depth estimates may be used in the diffusion process, and the fused features may be used to train a neural network of depth estimation unit 164 to predict the ground truth from the diffused depth maps.

Gaussian noise addition unit 162 may receive ground truth dense depth map 160, which may be an accurate representation of objects in an area that multi-camera input images 150 and sparse point cloud 152 represent. That is, ground truth dense depth map 160 may be a true representation of depth values for objects in the area, and may be used to train a neural network of depth estimation unit 164 to form or update depth estimation NN model 166. To train the neural network, according to the techniques of this disclosure, Gaussian noise addition unit 162 may add Gaussian noise to ground truth dense depth map 160 to produce a noisy ground truth depth map. Depth estimation unit 164 may use the noisy ground truth depth map and the fused feature data, executing depth estimation NN model 166, to produce recovered ground truth depth map 170.

Deep fusion at the feature level, as performed by cross-attention feature fusion unit 158, may refer to the process of combining features extracted from different modalities, in this case, LiDAR and camera image (which may be represented using respective RGB components) inputs, at a low-level feature representation. By doing so, the techniques of this disclosure may leverage both the raw and semantic information from the two modalities to produce a more accurate and robust depth estimation.

Since LiDAR data is sparse, each feature in the point cloud feature map may have multiple correspondences with its camera counterpart. Cross-attention feature fusion unit 158 may perform cross-attention to capture the most relevant correspondences between the two modalities. This means that the neural network of depth estimation unit 164 may be trained to attend to the most relevant spatial locations in the image feature map when processing a given LiDAR/point cloud feature.

Cross-attention feature fusion unit 158 may use a cross-attention mechanism that allows the neural network of depth estimation unit 164 to selectively attend to relevant features in both the image feature map and the LiDAR/point cloud feature map. Specifically, for each LiDAR feature, cross-attention feature fusion unit 158 may compute a set of attention weights that indicate the relevance of each camera feature. Cross-attention feature fusion unit 158 may use these attention weights to compute a weighted sum of the camera features, which cross-attention feature fusion unit 158 may then concatenate with the LiDAR feature to produce the fused feature representation.

To save computational resources and improve efficiency, the same camera encoder may be used to both perform depth estimation and feature fusion. This means that the encoder can extract useful features from the input data that are used for both tasks, rather than having to train separate encoders for each task. Such an encoder may be included in image feature extraction unit 154, which may also include a decoder.

More particularly, cross-attention feature fusion unit 158 may receive camera features C extracted from an image of an area near vehicle 100 of FIG. 1. Camera features C may have a size of H×W×C_{c}, where H and W are height and width spatial dimensions, and C_{c} represents a number of channels. Cross-attention feature fusion unit 158 also receives LiDAR/point cloud features L, which are of size D×H′×W×C₁, where D is the depth dimension for the area, H′ and W′ are height and width of the area, and C₁ is a number of channels. To compute cross-attention, cross-attention feature fusion unit 158 may first project the image and point cloud features from one modality (query) and the other modality (key and value) into a shared feature space into a shared feature space using learnable linear projections. The projected feature maps may be referred to as F_{lidar}, for the point cloud features, and F_{camera}, for the image features. Cross-attention feature fusion unit 158 may calculate the query (Q), key (K), and value (V) matrices as follows:

$${Q}_{lidar} = {W}_{q 1} * {F}_{lidar}$$

$${K}_{lidar} = {W}_{k 1} * {F}_{lidar}$$

$${V}_{lidar} = {W}_{v 1} * {F}_{lidar}$$

$${Q}_{camera} = {W}_{q c} * {F}_{camera}$$

$${K}_{camera} = {W}_{k c} * {F}_{camera}$$

$${V}_{camera} = {W}_{v c} * {F}_{camera}$$

In the equations above, ‘*’ represents matrix multiplication.

Next, cross-attention feature fusion unit 158 may compute attention weights. For camera features attending to LiDAR/point cloud features, attention weights may be computed as:

$${A}_{c 21} = softmax ( ( {Q}_{camera} * {K}_{lidar}^{T} ) / sqr t ( {d}_{k} ) )$$

In the formula above, K_{lidar}^{T} represents a transpose of the kay matrix K_{lidar}, and dₖ represents the dimensionality of the query and key vectors. The softmax function may ensure that the attention weights have a combined summation value of 1 across the spatial dimensions. Sqrt ( ) represents the square root function.

Similarly, for the LiDAR/point cloud features attending to the camera features, cross-attention feature fusion unit 158 may compute attention weights as:

$${A}_{12 c} = softmax ( ( {Q}_{lidar} * {K}_{camera}^{T} ) / sqrt ( {d}_{k} ) )$$

In the function above, K_{camera}^{T} represents the transpose of the K_{camera} matrix.

Next, cross-attention feature fusion unit 158 may use the attention weights to compute attended values. For the camera features attending to the LiDAR/point cloud features, cross-attention feature fusion unit 158 may calculate:

$${F}_{a\_camera} = {A}_{c 21} * {V}_{lidar}$$

Similarly, for the LiDAR/point cloud features, cross-attention feature fusion unit 158 may calculate:

$${F}_{a\_lidar} = {A}_{12 c} * {V}_{camera}$$

Finally, cross-attention feature fusion unit 158 may concatenate the attended features from both modalities (i.e., both the image features and the point cloud features) and pass them through a feed-forward network:

$${F}_{c r o s s} = FFN ( [ {F}_{a\_lidar} , {F}_{a\_camera} ] )$$

where FFN represents a feed-forward network, and [F_{a_lidar}, F_{a_camera}] denotes the concatenation of the attended features. In general, cross-attention allows the network to attend to the most relevant features in the other modality, thereby improving the quality of the fused features, leading to better depth completion performance.

Gaussian noise addition unit 162 may add Gaussian noise to ground truth dense depth map 160 as a generative task using DDPM. In general, Gaussian noise addition unit 162 may corrupt ground truth dense depth map 160 using Gaussian noise, and depth estimation NN model 166 may be trained to predict the original ground truth from this noisy estimate. This may start using a formulation of diffusion models, where the goal is to model the data distribution p(x) using a diffusion process:

$${x}_{T} ∼ p ( x ) , {x}_{t} = {f}_{t} ( {x}_{t - 1} , δ t )$$

where x_{T} represents ground truth dense depth map 160, and xₜ represents the estimated ground truth data at time t in the diffusion process. Function fₜ( ) maps xₜ₋₁ and added Gaussian noise δt to xₜ.

The diffusion process may involve two Markov chains: a forward chain, in which noise is gradually added to ground truth dense depth map 160 to generate noisy observations, and a reverse chain, in which the noisy observations are gradually denoised to recover the ground truth. This process may be tweaked by conditioning the diffusion model on the monocular depth estimates from the image data.

To model a conditional distribution p(x|e), where e represents the monocular depth estimate, the diffusion process may be modified as follows:

$${x}_{T} ∼ p ( x \vert e ) , {x}_{t} = {f}_{t} ( {x}_{t - 1} , δ t \vert e )$$

where fₜ in this example takes e as an additional input and the added noise δt is conditioned on e.

The data distribution (in this case, that of the depth map) may be d₀˜q(d₀). The distribution of dt, a corrupted depth map, can be modeled, given d0 and e, with mean;

$$( 1 - m t ) \sqrt{\overline{α t}} {d}_{0} + {m}_{t} \sqrt{\overline{α t}} e and covariance ( 1 - \overline{α t} ) * I :$$

$$q ( {d}_{t} \vert d 0 , e ) = N ( d t ; ( 1 - mt ) \sqrt{\overline{α t}} d0 + mt \sqrt{\overline{α t}} e ; ( 1 - \overline{α t} ) I )$$

where d0 represents ground truth dense depth map 160, mt is an interpolation parameter, α̅t̅ is a scheduling parameter, and I is the identity matrix.

Intuitively, this modification allows the diffusion process to better capture the structure and features of the input depth estimate e when adding noise to the ground truth. This can lead to more accurate and visually appealing completions of the depth map.

The training process may include training a neural network of depth estimation unit 164 to predict ground truth dense depth map 160 (d₀) from noisy depth map dₜ at each diffusion step t.

Loss calculation unit 168 may calculate a loss value representing differences between recovered ground truth depth map 170 (dₜ) and ground truth dense depth map 160 (d₀). The loss value may be used to update depth estimation NN model 166 to more accurately reconstruct the ground truth depth map. Loss calculation unit 168 may use the following loss function to train the neural network, which is the mean squared error between the predicted depth map and the ground truth depth map:

$$Ltrain = \frac{{‖ {f}_{Θ} ( {d}_{t} {P}_{i} , {I}_{i} , t ) - {d}_{0} ‖}^{2}}{2}$$

where f_{Θ} is the neural network with learnable parameters Θ, Pᵢ represents the image feature map, and Iᵢ represents the point cloud feature map.

The architecture of the neural network of depth estimation unit 164 may include a series of Transformer Encoder blocks that encode the noisy depth map given the fused feature maps from the camera and LiDAR sensors. The Transformer Encoder blocks may have the ability to handle sequential data such as text or time series and may be adapted to perform image processing tasks. The Transformer Encoder blocks may include a series of self-attention and feed-forward layers that can capture both local and global dependencies in the input data.

The progressive upsampling strategy may gradually refine the feature maps as they pass through the encoder. At each level, the feature maps are upsampled using interpolation or transposed convolution operations and concatenated with the corresponding feature maps from the previous level. This allows the neural network of depth estimation unit 164 to capture more fine-grained details in the depth map as the depth map progresses through the encoder.

During an inference step, depth estimation unit 164 may generate a sample from the distribution that was learned during the training step. Depth estimation unit 164 may then process this sample through T diffusion steps to refine the depth map estimate and produce the final output.

Depth estimation unit 164 may perform a conditional reverse process to retrieve the ground truth depth map from the noisy estimate and the monocular depth estimate. The process is similar to the forward diffusion process, but in reverse. At each step t, depth estimation unit 164 may model the distribution over the depth map given the previous step and the monocular depth estimate as:

$$p ( dT \vert dT - 1 , e ) = N ( dT ; \sqrt{\overline{α t}} e ; δ T I )$$

where e is the monocular depth estimate, δ_{T} is a learnable parameter that controls the variance of the distribution, and \overline{\sqrt{αt}} is the same scheduling parameter as in the forward diffusion process, as discussed above.

The reverse process may be used to retrieve the ground truth depth map by taking samples from the distribution at each step and passing them through the neural network of depth estimation unit 164 that was trained during the forward diffusion process. The neural network gradually refines the samples until the final ground truth depth map is obtained. Overall, the diffusion model and the neural network work together to provide an end-to-end solution for depth completion, where the model can generate high-quality depth maps from noisy or incomplete measurements, as well as retrieve the ground truth depth maps from noisy estimates and monocular depth information.

FIG. 4 is a block diagram illustrating an example vehicle 310 with a multi-camera system and autonomous driving controller 316 according to techniques of this disclosure. In particular, vehicle 310 includes cameras 312A-312G and LiDAR unit 314. In this example, cameras 312A and 312B are front-facing cameras with different focal lengths, cameras 312C and 312D are side-rear facing cameras, cameras 312E and 312F are side-front facing cameras, and camera 312G is a rear-facing camera. In this manner, imagery can be captured by the collection of cameras 312A-312G for a 360 degree view around vehicle 310.

LiDAR unit 314 may generate LiDAR/point cloud data around vehicle 310 in 360 degrees. Thus, LiDAR/point cloud data may be generated for images captured by each of cameras 312A-312G. Both images and LiDAR data may be provided to autonomous driving controller 316.

Autonomous driving controller 316 may include components similar to those of autonomous driving controller 120 of FIG. 2. For example, autonomous driving controller 316 may include a depth determination unit that performs the techniques of this disclosure, as discussed above, to extract features from the images and LiDAR data, fuse the extracted features, then generate a depth map from the fused features. Autonomous driving controller 120 may then use the depth map when making autonomous driving decisions to control vehicle 310.

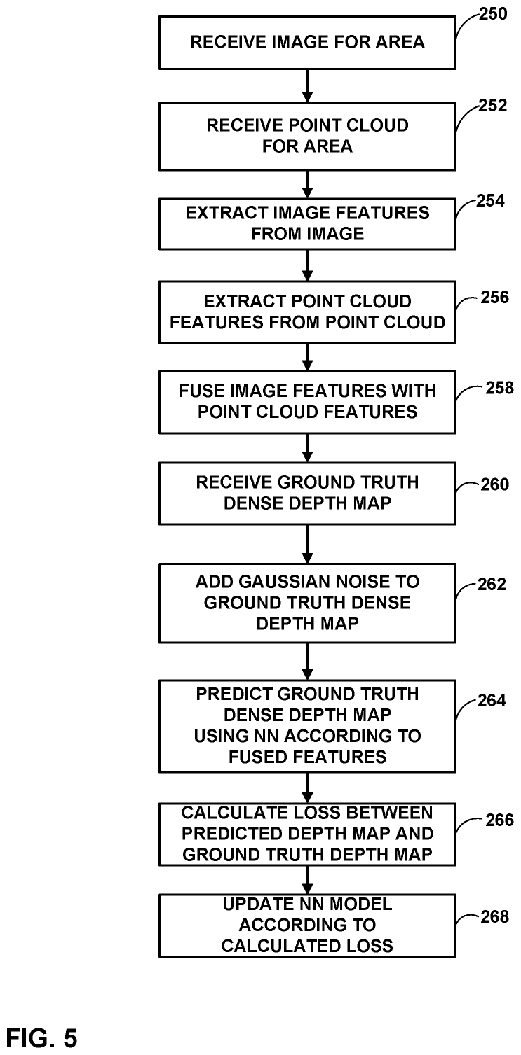

FIG. 5 is a flowchart illustrating an example method of training a neural network according to techniques of this disclosure. The method of FIG. 5 is described with respect to depth determination unit 180 of FIG. 3 for purposes of explanation. However, other units or devices may be configured to perform this or a similar method.

Initially, depth determination unit 180 receives an image for an area (250), e.g., an area around or near vehicle 100 (FIG. 1). Depth determination unit 180 also receives a point could cloud for the area (252), which may correspond to a point cloud generated by a LiDAR unit. Depth determination unit 180 may extract image features from the image (254) and extract point cloud features from the point cloud (256). Depth determination unit 180 may then fuse the image features with the point cloud features (258), e.g., using the process described above with respect to FIG. 3.

Depth determination unit 180 may also receive a ground truth dense depth map (260). The ground truth dense depth map may represent an accurate depth map for the area for which the image and point cloud data were captured. To train a neural network to generate a dense depth map, depth determination unit 180 may add Gaussian noise to the dense depth map (262), then predict a depth map using a neural network according to the fused features (264). Depth determination unit 180 may then calculate a loss between the predicted depth map and the ground truth dense depth map (266) and update a neural network model for the neural network according to the calculated loss (268). In this manner, depth determination unit 180 may train the neural network.

After the neural network has been trained in this manner, steps 250 to 258 may be performed, then depth estimates from the image data and the fused feature data may be processed by the neural network to generate a depth map, which may be used to, e.g., perform autonomous driving, ADAS, robot navigation, or the like. Thus, the steps involving the use of the ground truth data may be omitted once the neural network has been trained.

In this manner, the method of FIG. 5 represents an example of a method of training a neural network, including extracting image features from an image of an area, the image features representing objects in the area; extracting point cloud features from a point cloud representation of the area, the point cloud features representing the objects in the area; adding Gaussian noise to a ground truth depth map for the area to generate a noisy ground truth depth map, the ground truth depth map representing accurate positions of the objects in the area; and training a neural network using the image features, the point cloud features, and the noisy ground truth depth map to generate a depth map.

Various examples of the techniques of this disclosure are summarized in the following clauses:

Clause 1: A method of training a neural network, the method comprising: extracting image features from an image of an area, the image features representing objects in the area; extracting point cloud features from a point cloud representation of the area, the point cloud features representing the objects in the area; adding Gaussian noise to a ground truth depth map for the area to generate a noisy ground truth depth map, the ground truth depth map representing accurate positions of the objects in the area; and training a neural network using the image features, the point cloud features, and the noisy ground truth depth map to generate a depth map.

Clause 2: The method of clause 1, wherein training the neural network includes training the neural network to denoise the noisy point cloud ground truth depth map to recover the ground truth depth map.

Clause 3: The method of clause 1, wherein adding the Gaussian noise to the ground truth depth map includes adding a set of different amounts of Gaussian noise to the ground truth depth map to generate a set of distinct noisy ground truth depth maps, and wherein training the neural network comprises training the neural network using each of the set of distinct noisy ground truth depth maps.

Clause 4: The method of clause 1, further comprising performing deep feature fusion on the image features and the point cloud features using cross-attention to form a fused feature representation and providing the fused feature representation to the neural network.

Clause 5: The method of clause 4, wherein performing deep feature fusion comprises, for each of the point cloud features: computing a set of attention weights representing relevance of the image features that correspond to the point cloud feature; computing a weighted sum of the image features that correspond to the point cloud feature; and concatenating the weighted sum with the point cloud feature.

Clause 6: The method of clause 1, wherein the ground truth depth map comprises x_{T}, wherein the noisy ground truth depth map at time t comprises xₜ, the Gaussian noise comprises δt, e comprises an estimated depth map from the image, and adding the Gaussian noise to the ground truth depth map comprises calculating x_{T}˜p(x|e), xₜ=fₜ (xₜ₋₁, δt|e), where fₜ( ) comprises a diffusion function that maps xt−1 and the Gaussian noise, conditioned on the estimated depth map, to form xₜ, and p( ) represents a data distribution function.

Clause 7: The method of clause 1, wherein training the neural network comprises training the neural network using a loss function as a mean squared error between a predicted depth map and the ground truth depth map.

Clause 8: The method of clause 7, wherein the loss function comprises Lₜᵣₐᵢₙ=½∥f_{Θ}(dₜ, Pᵢ, Iᵢ, t)−d₀∥², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

Clause 9: A device for training a neural network, the device comprising: a memory configured to store a neural network model for the neural network; and a processing system comprising one or more processors implemented in circuitry, the processing system being configured to: extract image features from an image of an area, the image features representing objects in the area; extract point cloud features from a point cloud representation of the area, the point cloud features representing the objects in the area; add Gaussian noise to a ground truth depth map for the area to generate a noisy ground truth depth map, the ground truth depth map representing accurate positions of the objects in the area; and train the neural network using the image features, the point cloud features, and the noisy ground truth depth map to generate a depth map.

Clause 10: The device of clause 9, wherein to train the neural network, the processing system is configured to train the neural network to denoise the noisy point cloud ground truth depth map to recover the ground truth depth map.

Clause 11: The device of clause 9, wherein to add the Gaussian noise to the ground truth depth map, the processing system is configured to add a set of different amounts of Gaussian noise to the ground truth depth map to generate a set of distinct noisy ground truth depth maps, and wherein to train the neural network, the processing system is configured to train the neural network using each of the set of distinct noisy ground truth depth maps.

Clause 12: The device of clause 9, wherein the processing system is further configured to perform deep feature fusion on the image features and the point cloud features using cross-attention to form a fused feature representation and to provide the fused feature representation to the neural network.

Clause 13: The device of clause 12, wherein to perform deep feature fusion, the processing system is configured to, for each of the point cloud features: compute a set of attention weights representing relevance of the image features that correspond to the point cloud feature; compute a weighted sum of the image features that correspond to the point cloud feature; and concatenate the weighted sum with the point cloud feature.

Clause 14: The device of clause 9, wherein the ground truth depth map comprises x_{T}, wherein the noisy ground truth depth map at time t comprises xₜ, the Gaussian noise comprises δt, e comprises an estimated depth map from the image, and to add the Gaussian noise to the ground truth depth map, the processing system is configured to calculate x_{T}˜p(x|e), xₜ=fₜ(xₜ₋₁, δt|e), where fₜ ( ) comprises a diffusion function that maps xt−1 and the Gaussian noise, conditioned on the estimated depth map, to form xₜ, and p( ) represents a data distribution function.

Clause 15: The device of clause 9, wherein to train the neural network, the processing system is configured to train the neural network model using a loss function as a mean squared error between a predicted depth map and the ground truth depth map.

Clause 16: The device of clause 15, wherein the loss function comprises Lₜᵣₐᵢₙ=½∥f_{Θ}(dₜ, Pᵢ, Iᵢ, t)−d₀∥², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

Clause 17: A device for training a neural network, the device comprising: means for extracting image features from an image of an area, the image features representing objects in the area; means for extracting point cloud features from a point cloud representation of the area, the point cloud features representing the objects in the area; means for adding Gaussian noise to a ground truth depth map for the area to generate a noisy ground truth depth map, the ground truth depth map representing accurate positions of the objects in the area; and means for training a neural network using the image features, the point cloud features, and the noisy ground truth depth map to generate a depth map.

Clause 18: The device of clause 17, wherein the means for training the neural network includes means for training the neural network to denoise the noisy point cloud ground truth depth map to recover the ground truth depth map.

Clause 19: The device of clause 17, wherein the means for adding the Gaussian noise to the ground truth depth map includes means for adding a set of different amounts of Gaussian noise to the ground truth depth map to generate a set of distinct noisy ground truth depth maps, and wherein the means for training the neural network comprises means for training the neural network using each of the set of distinct noisy ground truth depth maps.

Clause 20: The device of clause 17, further comprising means for performing deep feature fusion on the image features and the point cloud features using cross-attention to form a fused feature representation, and means for providing the fused feature representation to the neural network.

Clause 21: The device of clause 20, wherein the means for performing deep feature fusion comprises: means for computing, for each of the point cloud features, a set of attention weights representing relevance of the image features that correspond to the point cloud feature; means for computing, for each of the point cloud features, a weighted sum of the image features that correspond to the point cloud feature; and means for concatenating, for each of the point cloud features, the weighted sum with the point cloud feature.

Clause 22: The device of clause 17, wherein the ground truth depth map comprises x_{T}, wherein the noisy ground truth depth map at time t comprises xₜ, the Gaussian noise comprises δt, e comprises an estimated depth map from the image, and the means for adding the Gaussian noise to the ground truth depth map comprises means for calculating x_{T}˜p(x|e), xₜ=fₜ (xₜ₋₁, δt|e), where fₜ ( ) comprises a diffusion function that maps xt−1 and the Gaussian noise, conditioned on the estimated depth map, to form xₜ, and p( ) represents a data distribution function.

Clause 23: The device of clause 17, wherein the means for training the neural network comprises means for training the neural network using a loss function as a mean squared error between a predicted depth map and the ground truth depth map.

Clause 24: The device of clause 23, wherein the loss function comprises Lₜᵣₐᵢₙ=½ ∥f_{Θ}(dₜ, Pᵢ, Iᵢ, t)−d₀∥², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

Clause 25: A computer-readable storage medium having stored thereon instructions that, when executed, cause a processing system to perform the method of any of clauses 1-8.

Clause 26: A method of training a neural network, the method comprising: extracting image features from an image of an area, the image features representing objects in the area; extracting point cloud features from a point cloud representation of the area, the point cloud features representing the objects in the area; adding Gaussian noise to a ground truth depth map for the area to generate a noisy ground truth depth map, the ground truth depth map representing accurate positions of the objects in the area; and training a neural network using the image features, the point cloud features, and the noisy ground truth depth map to generate a depth map.

Clause 27: The method of clause 26, wherein training the neural network includes training the neural network to denoise the noisy point cloud ground truth depth map to recover the ground truth depth map.

Clause 28: The method of any of clauses 26 and 27, wherein adding the Gaussian noise to the ground truth depth map includes adding a set of different amounts of Gaussian noise to the ground truth depth map to generate a set of distinct noisy ground truth depth maps, and wherein training the neural network comprises training the neural network using each of the set of distinct noisy ground truth depth maps.

Clause 29: The method of any of clauses 26-28, further comprising performing deep feature fusion on the image features and the point cloud features using cross-attention to form a fused feature representation and providing the fused feature representation to the neural network.

Clause 30: The method of clause 29, wherein performing deep feature fusion comprises, for each of the point cloud features: computing a set of attention weights representing relevance of the image features that correspond to the point cloud feature; computing a weighted sum of the image features that correspond to the point cloud feature; and concatenating the weighted sum with the point cloud feature.

Clause 31: The method of any of clauses 26-30, wherein the ground truth depth map comprises x_{T}, wherein the noisy ground truth depth map at time t comprises xₜ, the Gaussian noise comprises δt, e comprises an estimated depth map from the image, and adding the Gaussian noise to the ground truth depth map comprises calculating x_{T}˜p(x|e), xₜ=fₜ (xₜ₋₁, δt|e), where fₜ ( ) comprises a diffusion function that maps xt−1 and the Gaussian noise, conditioned on the estimated depth map, to form xₜ, and p( ) represents a data distribution function.

Clause 32: The method of any of clauses 26-31, wherein training the neural network comprises training the neural network using a loss function as a mean squared error between a predicted depth map and the ground truth depth map.

Clause 33: The method of clause 32, wherein the loss function comprises Lₜᵣₐᵢₙ=½ |f_{Θ}(dₜ, Pᵢ, Iᵢ, t)−d₀|², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

Clause 34: A device for training a neural network, the device comprising: a memory configured to store a neural network model for the neural network; and a processing system comprising one or more processors implemented in circuitry, the processing system being configured to: extract image features from an image of an area, the image features representing objects in the area; extract point cloud features from a point cloud representation of the area, the point cloud features representing the objects in the area; add Gaussian noise to a ground truth depth map for the area to generate a noisy ground truth depth map, the ground truth depth map representing accurate positions of the objects in the area; and train the neural network using the image features, the point cloud features, and the noisy ground truth depth map to generate a depth map.

Clause 35: The device of clause 34, wherein to train the neural network, the processing system is configured to train the neural network to denoise the noisy point cloud ground truth depth map to recover the ground truth depth map.

Clause 36: The device of any of clauses 34 and 35, wherein to add the Gaussian noise to the ground truth depth map, the processing system is configured to add a set of different amounts of Gaussian noise to the ground truth depth map to generate a set of distinct noisy ground truth depth maps, and wherein to train the neural network, the processing system is configured to train the neural network using each of the set of distinct noisy ground truth depth maps.

Clause 37: The device of any of clauses 34-36, wherein the processing system is further configured to perform deep feature fusion on the image features and the point cloud features using cross-attention to form a fused feature representation and to provide the fused feature representation to the neural network.

Clause 38: The device of clause 37, wherein to perform deep feature fusion, the processing system is configured to, for each of the point cloud features: compute a set of attention weights representing relevance of the image features that correspond to the point cloud feature; compute a weighted sum of the image features that correspond to the point cloud feature; and concatenate the weighted sum with the point cloud feature.

Clause 39: The device of any of clauses 34-38, wherein the ground truth depth map comprises x_{T}, wherein the noisy ground truth depth map at time t comprises xₜ, the Gaussian noise comprises δt, e comprises an estimated depth map from the image, and to add the Gaussian noise to the ground truth depth map, the processing system is configured to calculate x_{T}˜p(x|e), xₜ=fₜ (xₜ₋₁, δt|e), where fₜ ( ) comprises a diffusion function that maps xt−1 and the Gaussian noise, conditioned on the estimated depth map, to form xₜ, and p( ) represents a data distribution function.

Clause 40: The device of any of clauses 34-39, wherein to train the neural network, the processing system is configured to train the neural network model using a loss function as a mean squared error between a predicted depth map and the ground truth depth map.

Clause 41: The device of clause 40, wherein the loss function comprises Lₜᵣₐᵢₙ=½ |f_{Θ}(dₜ, Pᵢ, Iᵢ, t)−d₀|², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

Clause 42: A device for training a neural network, the device comprising: means for extracting image features from an image of an area, the image features representing objects in the area; means for extracting point cloud features from a point cloud representation of the area, the point cloud features representing the objects in the area; means for adding Gaussian noise to a ground truth depth map for the area to generate a noisy ground truth depth map, the ground truth depth map representing accurate positions of the objects in the area; and means for training a neural network using the image features, the point cloud features, and the noisy ground truth depth map to generate a depth map.

Clause 43: The device of clause 42, wherein the means for training the neural network includes means for training the neural network to denoise the noisy point cloud ground truth depth map to recover the ground truth depth map.

Clause 44: The device of any of clauses 42 and 43, wherein the means for adding the Gaussian noise to the ground truth depth map includes means for adding a set of different amounts of Gaussian noise to the ground truth depth map to generate a set of distinct noisy ground truth depth maps, and wherein the means for training the neural network comprises means for training the neural network using each of the set of distinct noisy ground truth depth maps.

Clause 45: The device of any of clauses 42-44, further comprising means for performing deep feature fusion on the image features and the point cloud features using cross-attention to form a fused feature representation, and means for providing the fused feature representation to the neural network.

Clause 46: The device of clause 45, wherein the means for performing deep feature fusion comprises: means for computing, for each of the point cloud features, a set of attention weights representing relevance of the image features that correspond to the point cloud feature; means for computing, for each of the point cloud features, a weighted sum of the image features that correspond to the point cloud feature; and means for concatenating, for each of the point cloud features, the weighted sum with the point cloud feature.

Clause 47: The device of any of clauses 42-46, wherein the ground truth depth map comprises x_{T}, wherein the noisy ground truth depth map at time t comprises xₜ, the Gaussian noise comprises δt, e comprises an estimated depth map from the image, and the means for adding the Gaussian noise to the ground truth depth map comprises means for calculating x_{T}˜p(x|e), xₜ=fₜ(xₜ₋₁, δt|e), where fₜ ( ) comprises a diffusion function that maps xt−1 and the Gaussian noise, conditioned on the estimated depth map, to form xₜ, and p( ) represents a data distribution function.

Clause 48: The device of any of clauses 42-47, wherein the means for training the neural network comprises means for training the neural network using a loss function as a mean squared error between a predicted depth map and the ground truth depth map.

Clause 49: The device of clause 49, wherein the loss function comprises Lₜᵣₐᵢₙ=½ ∥f_{Θ}(dₜ, Pᵢ, Iᵢ, t)−d₀∥², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

Clause 50: A device for processing image data using a neural network, the device comprising: a memory configured to store a neural network model for the neural network, the neural network having been trained using Gaussian noise added to a ground truth depth map for a first area, first image features extracted from a first image of the first area, and point cloud features extracted from a first point cloud representation of the first area, the first image features representing first objects in the first area, and the first point cloud features representing the first objects in the first area; and a processing system comprising one or more processors implemented in circuitry, the processing system being configured to: extract second image features from a second image of a second area, the second image features representing second objects in the second area; extract second point cloud features from a second point cloud representation of the second area, the second point cloud features representing the second objects in the second area; and provide the second image features and the second point cloud features to the neural network to generate a depth map for the second area.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media d₀ not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of training a neural network, the method comprising:
extracting image features from an image of an area, the image features representing objects in the area;
extracting point cloud features from a point cloud representation of the area, the point cloud features representing the objects in the area;
adding Gaussian noise to a ground truth depth map for the area to generate a noisy ground truth depth map, the ground truth depth map representing accurate positions of the objects in the area; and
training a neural network using the image features, the point cloud features, and the noisy ground truth depth map to generate a depth map.

2. The method of claim 1, wherein training the neural network includes training the neural network to denoise the noisy point cloud ground truth depth map to recover the ground truth depth map.

3. The method of claim 1, wherein adding the Gaussian noise to the ground truth depth map includes adding a set of different amounts of Gaussian noise to the ground truth depth map to generate a set of distinct noisy ground truth depth maps, and wherein training the neural network comprises training the neural network using each of the set of distinct noisy ground truth depth maps.

4. The method of claim 1, further comprising performing deep feature fusion on the image features and the point cloud features using cross-attention to form a fused feature representation and providing the fused feature representation to the neural network.

5. The method of claim 4, wherein performing deep feature fusion comprises, for each of the point cloud features:
computing a set of attention weights representing relevance of the image features that correspond to the point cloud feature;
computing a weighted sum of the image features that correspond to the point cloud feature; and
concatenating the weighted sum with the point cloud feature.

6. The method of claim 1, wherein the ground truth depth map comprises x_{T}, wherein the noisy ground truth depth map at time t comprises xₜ, the Gaussian noise comprises δt, e comprises an estimated depth map from the image, and adding the Gaussian noise to the ground truth depth map comprises calculating x_{T}˜p(x|e), xₜ=fₜ(xₜ₋₁, δt|e), where fₜ( ) comprises a diffusion function that maps xₜ−1 and the Gaussian noise, conditioned on the estimated depth map, to form xₜ, and p( ) represents a data distribution function.

7. The method of claim 1, wherein training the neural network comprises training the neural network using a loss function as a mean squared error between a predicted depth map and the ground truth depth map.

8. The method of claim 7, wherein the loss function comprises Lₜᵣₐᵢₙ=½ ∥f_{Θ}(dₜ, Pᵢ, Iᵢ, t)−d₀∥², where f_{Θ}( ) represents the neural network with learnable parameters Θ, Pᵢ represents the image features, Iᵢ represents the point cloud features, dₜ represents the noisy ground truth depth map at diffusion step t, and d₀ represents the ground truth depth map.

9. A device for training a neural network, the device comprising:
a memory configured to store a neural network model for the neural network; and
a processing system comprising one or more processors implemented in circuitry, the processing system being configured to:
extract image features from an image of an area, the image features representing objects in the area;
extract point cloud features from a point cloud representation of the area, the point cloud features representing the objects in the area;
add Gaussian noise to a ground truth depth map for the area to generate a noisy ground truth depth map, the ground truth depth map representing accurate positions of the objects in the area; and
train the neural network using the image features, the point cloud features, and the noisy ground truth depth map to generate a depth map.

10. The device of claim 9, wherein to train the neural network, the processing system is configured to train the neural network to denoise the noisy point cloud ground truth depth map to recover the ground truth depth map.

11. The device of claim 9, wherein to add the Gaussian noise to the ground truth depth map, the processing system is configured to add a set of different amounts of Gaussian noise to the ground truth depth map to generate a set of distinct noisy ground truth depth maps, and wherein to train the neural network, the processing system is configured to train the neural network using each of the set of distinct noisy ground truth depth maps.

12. The device of claim 9, wherein the processing system is further configured to perform deep feature fusion on the image features and the point cloud features using cross-attention to form a fused feature representation and to provide the fused feature representation to the neural network.

13. The device of claim 12, wherein to perform deep feature fusion, the processing system is configured to, for each of the point cloud features:
compute a set of attention weights representing relevance of the image features that correspond to the point cloud feature;
compute a weighted sum of the image features that correspond to the point cloud feature; and
concatenate the weighted sum with the point cloud feature.

14. The device of claim 9, wherein the ground truth depth map comprises x_{T}, wherein the noisy ground truth depth map at time t comprises xₜ, the Gaussian noise comprises δt, e comprises an estimated depth map from the image, and to add the Gaussian noise to the ground truth depth map, the processing system is configured to calculate x_{T}˜p(x|e), xₜ=fₜ (xₜ₋₁, δt|e), where fₜ ( ) comprises a diffusion function that maps xₜ₋₁ and the Gaussian noise, conditioned on the estimated depth map, to form xₜ, and p( ) represents a data distribution function.

15. The device of claim 9, wherein to train the neural network, the processing system is configured to train the neural network model using a loss function as a mean squared error between a predicted depth map and the ground truth depth map.

16. The device of claim 15, wherein the loss function comprises Lₜᵣₐᵢₙ=½ ∥f_{Θ}(dₜ, Pᵢ, Iᵢ, t)−d₀∥², where f_{Θ}( ) represents the neural network with learnable parameters Θ, Pᵢ represents the image features, Iᵢ represents the point cloud features, de represents the noisy ground truth depth map at diffusion step t, and d₀ represents the ground truth depth map.

17. A device for processing image data using a neural network, the device comprising:
a memory configured to store a neural network model for the neural network, the neural network having been trained using Gaussian noise added to a ground truth depth map for a first area, first image features extracted from a first image of the first area, and point cloud features extracted from a first point cloud representation of the first area, the first image features representing first objects in the first area, and the first point cloud features representing the first objects in the first area; and
a processing system comprising one or more processors implemented in circuitry, the processing system being configured to:
extract second image features from a second image of a second area, the second image features representing second objects in the second area;
extract second point cloud features from a second point cloud representation of the second area, the second point cloud features representing the second objects in the second area; and
provide the second image features and the second point cloud features to the neural network to generate a depth map for the second area.
